(19) United States
(12) Patent Application Publication
(10) Pub. No.: US 2021/0090292 A1
(43) Pub. Date: Mar. 25, 2021

(54) THREE-DIMENSIONAL MEASUREMENT INTERFACE

(71) Applicant: Standard Cyborg, Inc., San Francisco, CA (US)

(72) Inventors: Jeffrey Huber, San Francisco, CA (US); Aaron Thompson, San Francisco, CA (US); Ricky Reusser, Oakland, CA (US); Dustin Dorroh, San Francisco, CA (US); Eric Arnebäck, Hyssna (SE); Garrett Spiegel, San Francisco, CA (US)

(21) Appl. No.: 16/580,919

(22) Filed: Sep. 24, 2019

(51) Int. Cl. G06T 7/73; G06T 7/50; G06T 1/60; G06T 1/20

(52) U.S. Cl. CPC G06T 7/75; G06T 7/50; G06T 2219/20; G06T 1/20; G06T 1/60

(57) ABSTRACT

A 3D measurement system to generate and cause display of a 3D measurement interface to present values depicting dimensions of one or more objects depicted in a presentation of a 3D model at a client device. According to certain embodiments, the system is configured to perform operations that include: accessing a data stream at a client device, the data stream comprising depth data; generating a 3D model based on at least the depth data; causing display of a presentation of the 3D model at the client device; receiving an input that selects a dimension of the 3D model; and causing display of a value based on the dimension in response to the input that selects the dimension.

### TECHNICAL FIELD

Embodiments of the present disclosure relate generally to three-dimensional (3D) modeling, and more particularly, to systems for generating measurements based on 3D models.

### BACKGROUND

3D modeling is the process of developing a mathematical representation of a surface of an object in three dimensions, via specialized sensors and software. 3D models represent the surfaces of objects using a collection of points in 3D space, connected by various geometric entities such as triangles, lines, and curved surfaces.

A depth map is an image or image channel that contains information relating to the distance of the surfaces of scene objects from a viewpoint. The term is related to and may be analogous to depth buffer, Z-buffer, Z-buffering and Z-depth. The “Z” in these latter terms relates to a convention that the central axis of view of a camera is in the direction of the camera's Z axis, and not to the absolute Z axis of a scene.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram showing an example 3D modeling system for exchanging data (e.g., messages and associated content) over a network in accordance with some embodiments, wherein the 3D modeling system includes a 3D modeling toolkit.

FIG. 2 is a block diagram illustrating various modules of a 3D modeling toolkit, according to certain example embodiments.

FIG. 3 is a flowchart illustrating a method for presenting a value of a dimension, according to certain example embodiments.

FIG. 4 is a flowchart illustrating a method for filtering a collection of data objects, according to certain example embodiments.

FIG. 5 is a flowchart illustrating a method for presenting a value of a dimension, according to certain example embodiments.

FIG. 6 is an interface flow diagram illustrating interfaces presented by a 3D measurement system, according to certain example embodiments.

FIG. 7 is an interface diagram depicting a presentation of a value of a dimension, according to certain example embodiments.

FIG. 8 is a block diagram illustrating a representative software architecture, which may be used in conjunction with various hardware architectures herein described and used to implement various embodiments.

FIG. 9 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

Example embodiments described herein relate to a 3D measurement system to generate and cause display of a 3D measurement interface to present values depicting dimensions of one or more objects depicted in a presentation of a 3D model at a client device. According to certain embodiments, the system is configured to perform operations that include: accessing a data stream at a client device, the data stream comprising depth data; generating a 3D model based on at least the depth data; causing display of a presentation of the 3D model at the client device; receiving an input that selects a dimension of the 3D model; and causing display of a value based on the dimension in response to the input that selects the dimension.

In some example embodiments, the 3D measurement system accesses a repository that comprises a collection of data objects and filters the collection of data objects based on the value of the dimension. For example, each data object among the collection of data objects may comprise a set of attributes. Responsive to determining a value of a dimension of a 3D model, the 3D measurement system may filter the collection of data objects based on the corresponding attributes of the data objects and the value of the dimension. The filtered collection of data objects may then be presented at the client device.

In some embodiments, the data stream accessed by the 3D measurement system may comprise depth data, as well as image data. In such embodiments, the 3D measurement system may identify one or more objects depicted by the data stream in order to identify one or more dimensions to be measured. The one or more dimensions to be measured may then be presented to the user at the client device, whereby the user may provide an input selecting a dimension. Responsive to receiving a selection of a dimension, the 3D measurement system may cause display of a value of the dimension of the object.

In some embodiments, a user of the 3D measurement system may provide inputs identifying points within the presentation of the 3D model. Based on the points identified by the inputs, the 3D measurement system may access the corresponding depth data in order to identify a dimension to be measured. Responsive to receiving the inputs that select the points in the presentation of the 3D model, the 3D measurement system may present a visual indicator in the presentation of the 3D model, wherein the visual indicator identifies the dimension to be measured. For example, the visual indicator may be presented as augmented-reality content at a position within the presentation of the 3D model.

Consider an illustrative example from a user perspective. A common problem associated with preparing custom fit articles and devices is gathering accurate measurement information of relevant dimensions of a particular object or body part. Such measurements are often difficult to obtain conveniently and are often inaccurate due to variations in measurement methods. Accordingly, by providing users with a system to generate a 3D model, and one or more interfaces to present measurements of dimensions of objects depicted by the 3D model, a more consistent, and accurate method of measuring dimensions is achieved.

A user of the 3D measurement system may seek to collect measurements of one or more dimensions of their head in order to provide the measurements to a helmet manufacturer for the purposes of creating a custom fit helmet. The 3D measurement system accesses data streams comprising image data and depth data to generate a 3D model of the user's head. Upon detecting that the 3D model depicts the user's head, the 3D measurement system may identify one or more relevant dimensions to be measured (e.g., circumference), and accesses the data stream to generate a value of the dimension. The 3D measurement system may then present the value(s) to the user at the client device, or in some embodiments may automatically present the value(s) to a second client device (associated with a helmet manufacturer).

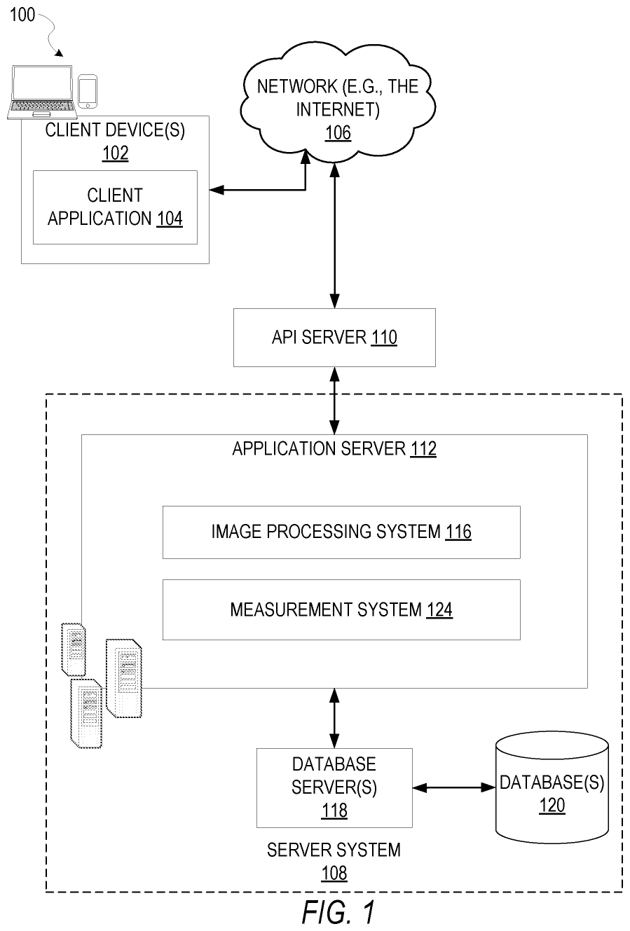

FIG. 1 is a block diagram showing an example modeling system 100 for exchanging data over a network. The modeling system 100 include one or more client devices 102 which host a number of applications including a client application 104. Each client application 104 is communicatively coupled to other instances of the client application 104 and a server system 108 via a network 106 (e.g., the Internet).

Accordingly, each client application 104 is able to communicate and exchange data with another client application 104 and with the server system 108 via the network 106. The data exchanged between client applications 104, and between a client application 104 and the server system 108, includes functions (e.g., commands to invoke functions) as well as payload data (e.g., text, audio, video or other multimedia data).

The server system 108 provides server-side functionality via the network 106 to a particular client application 104. While certain functions of the modeling system 100 are described herein as being performed by either a client application 104 or by the server system 108, it will be appreciated that the location of certain functionality either within the client application 104 or the server system 108 is a design choice. For example, it may be technically preferable to initially deploy certain technology and functionality within the server system 108, but to later migrate this technology and functionality to the client application 104 where a client device 102 has a sufficient processing capacity.

The server system 108 supports various services and operations that are provided to the client application 104. Such operations include transmitting data to, receiving data from, and processing data generated by the client application 104. In some embodiments, this data includes, image data, Red-blue-green (RBG) data, depth data, inertial measurement unit (IMU) data, client device information, geolocation information, as examples. In other embodiments, other data is used. Data exchanges within the modeling system 100 are invoked and controlled through functions available via GUIs of the client application 104.

Turning now specifically to the server system 108, an Application Program Interface (API) server 110 is coupled to, and provides a programmatic interface to, an application server 112. The application server 112 is communicatively coupled to a database server 118, which facilitates access to a database 120 in which is stored data associated with messages processed by the application server 112.

Dealing specifically with the Application Program Interface (API) server 110, this server receives and transmits data between the client device 102 and the application server 112. Specifically, the Application Program Interface (API) server 110 provides a set of interfaces (e.g., routines and protocols) that can be called or queried by the client application 104 in order to invoke functionality of the application server 112. The Application Program Interface (API) server 110 exposes various functions supported by the application server 112, including account registration, login functionality, the sending of messages or content, via the application server 112, from a particular client application 104 to another client application 104, the sending of media files (e.g., images or video) from a client application 104 to the server application 114, and for possible access by another client application 104, opening and application event (e.g., relating to the client application 104).

The application server 112 hosts a number of applications and subsystems, including a server application 114, an image processing system 116, and a measurement system 124. The server application 114 implements a number of image processing technologies and functions, particularly related to the aggregation and other processing of content (e.g., image data) received from multiple instances of the client application 104. As will be described in further detail, the image data from multiple sources may be aggregated into collections of content. These collections are then made available, by the server application 114, to the client application 104. Other processor and memory intensive processing of data may also be performed server-side by the messaging server application 114, in view of the hardware requirements for such processing.

The application server 112 also includes an image processing system 116 that is dedicated to performing various image processing operations, typically with respect to images or video received from one or more client devices 102 at the messaging server application 114.

The application server 112 is communicatively coupled to a database server 118, which facilitates access to a database 120 in which is stored data associated with image data processed by the messaging server application 114.

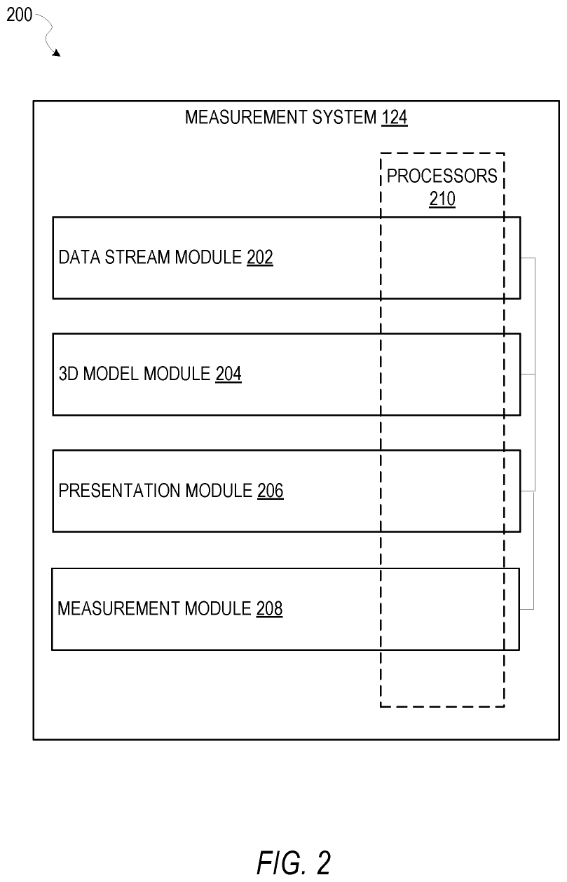

FIG. 2 is a block diagram illustrating components of the measurement system 124 that configure the measurement system 124 to present measurements of one or more dimensions of an object depicted by a 3D model, according to certain example embodiments.

The measurement system 124 is shown as including a data stream module 202, a 3D model module 204, a presentation module 206, and a measurement module 208, all configured to communicate with each other (e.g., via a bus, shared memory, or a switch). Any one or more of these modules may be implemented using one or more processors 210 (e.g., by configuring such one or more processors to perform functions described for that module) and hence may include one or more of the processors 210.

Any one or more of the modules described may be implemented using hardware alone (e.g., one or more of the processors 210 of a machine) or a combination of hardware and software. For example, any module described of the measurement system 124 may physically include an arrangement of one or more of the processors 210 (e.g., a subset of or among the one or more processors of the machine) configured to perform the operations described herein for that module. As another example, any module of the measurement system 124 may include software, hardware, or both, that configure an arrangement of one or more processors 210 (e.g., among the one or more processors of the machine) to perform the operations described herein for that module. Accordingly, different modules of the measurement system 124 may include and configure different arrangements of such processors 210 or a single arrangement of such processors 210 at different points in time. Moreover, any two or more modules of the measurement system 124 may be combined into a single module, and the functions described herein for a single module may be subdivided among multiple modules. Furthermore, according to various example embodiments, modules described herein as being implemented within a single machine, database, or device may be distributed across multiple machines, databases, or devices.

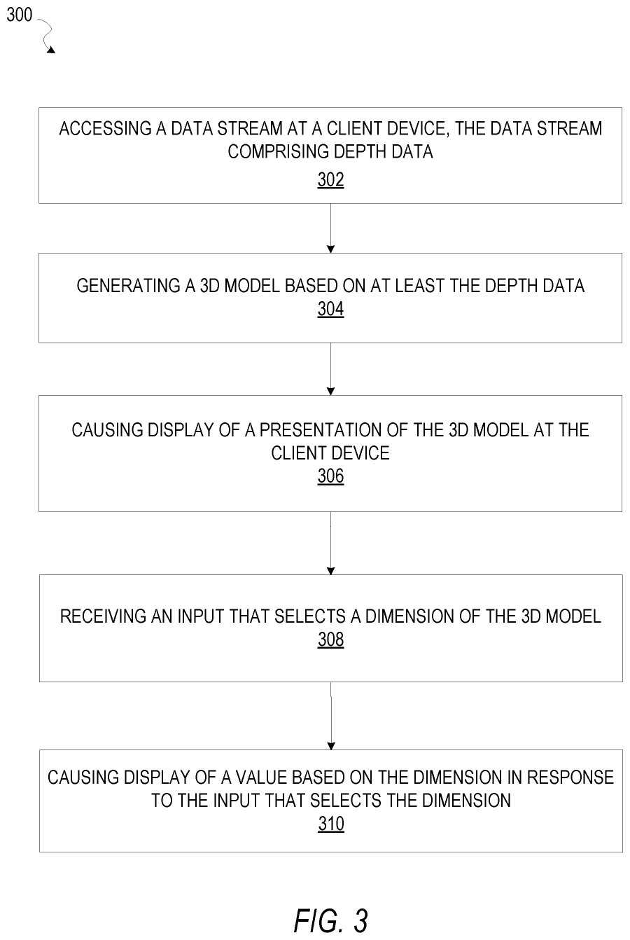

FIG. 3 is a flowchart illustrating a method 300 for presenting a value of a dimension, according to certain example embodiments. Operations of the method 300 may be performed by the modules described above with respect to FIG. 2. As shown in FIG. 3, the method 300 includes one or more operations 302, 304, 306, 308, and 310.

At operation 302, the data stream module 202 access a data stream at a client device 102. The data stream may comprise image data, Red-blue-green (RBG) data, depth data, inertial measurement unit (IMU) data, client device information, as well as geolocation information. In other embodiments, other data is used. For example, the data stream module 202 may access one or more input components of the client device 102 to access the data stream.

At operation 304, the 3D model module 204 generates a 3D model based on the data from the data stream, including the depth data and the image data. For example, in some embodiments the 3D model module 204 may generate the 3D model based on the data stream by generating a point cloud based on the depth data, wherein the point cloud comprises a set of data points that define surface features of one or more objects depicted by the data stream.

At operation 306, the presentation module 206 causes display of a presentation of the 3D model generated by the 3D model module 204 at the client device 102. At operation 308, the measurement module 208 identifies one or more dimensions of the 3D model. For example, the measurement module 208 may identify an object depicted by the 3D model by performing one or more object recognition techniques, and then identify the dimensions to be measured based on the object. In further embodiments, the measurement module 208 may identify dimensions to be measured based on attributes of the 3D model presented at the client device 102.

At operation 310, the measurement module 208 determines a value of the dimension based on at least the depth data and causes display of the value within the presentation of the 3D model at the client device 102.

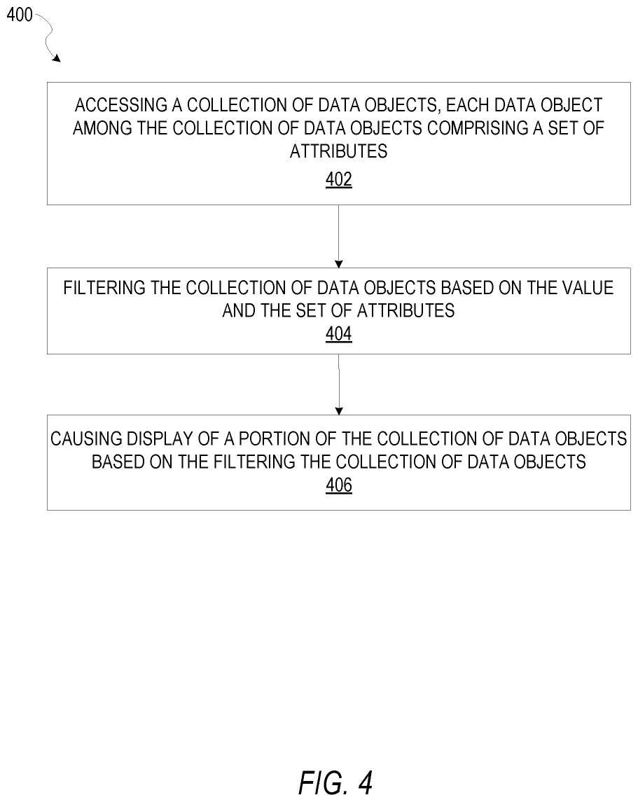

FIG. 4 is a flowchart illustrating a method 400 for filtering a collection of data objects, according to certain example embodiments. Operations of the method 400 may be performed by the modules described above with respect to FIG. 2. As shown in FIG. 4, the method 400 includes one or more operations 402, 404, and 406, that may be performed as a part of (e.g., a subroutine, or subsequent to) the method 300 depicted in FIG. 3.

At operation 402, responsive to the measurement module 208 determining a value of the dimension of the 3D object, the measurement module 208 accesses a collection of data objects at a repository, such as the database 120, wherein each data object among the collection of data objects comprises a set of attributes. For example, the attributes may include product sizing information.

At operation 404, the measurement module 208 filters the collection of data objects based on the corresponding attributes of each data object among the collection of data objects and the value of the dimension calculated by the measurement module 208.

At operation 406, the presentation module 206 causes display of a portion of the collection of data objects at the client device 102. For example, the portion of the collection of data objects may be based on the filtering of the collection of data objects based on the value.

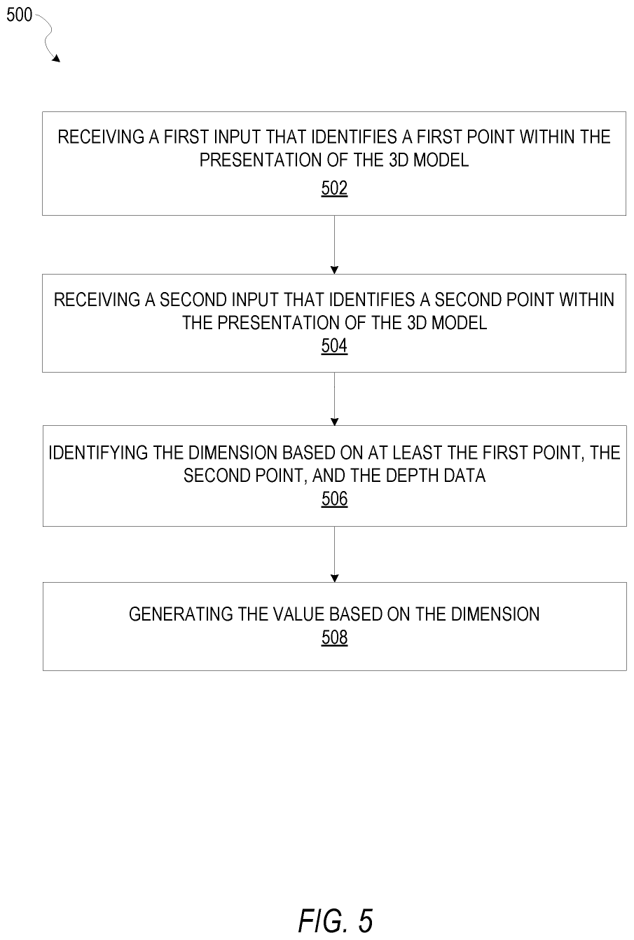

FIG. 5 is a flowchart illustrating a method 500 for presenting a value of a dimension, according to certain example embodiments. Operations of the method 500 may be performed by the modules described above with respect to FIG. 2. As shown in FIG. 5, the method 500 includes one or more operations 502, 504, 506, and 508, that may be performed as a part of (e.g., a subroutine, or subsequent to) the method 300 depicted in FIG. 3.

At operation 502, the presentation module 206 receives a first input that identifies a first point within the presentation of the 3D model presented at the client device 102. At operation 504, the presentation module 206 receives a second input that identifies a second point within the presentation of the 3D model.

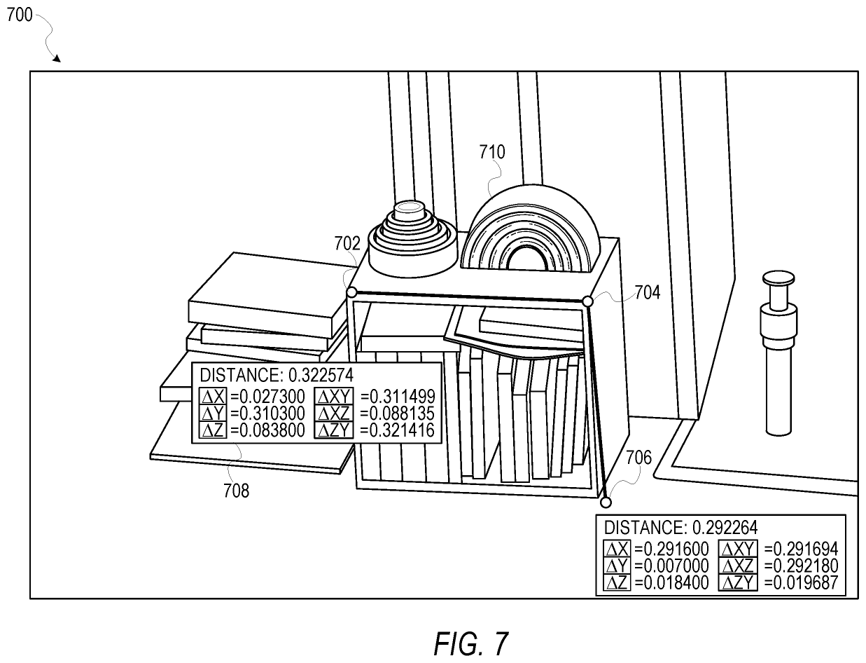

For example, as seen in the interface diagram 700 depicted in FIG. 7, the 3D model module 204 may generate and cause display of a presentation of a 3D model 710 at the client device 102. A user of the client device 102 may provide the first input 702, and the second input 704 to identify a dimension of the 3D model 710 to be measured.

At operation 506, responsive to receiving the first input (i.e., the first input 702) and the second input (i.e., the second input 704), the 3D measurement system 124 determines a dimension of the 3D model 710 to be measured based on positions of the first input and the second input, and depth data from the data stream.

At operation 508, the presentation module 206 generates a value of the dimensions of the 3D model (i.e., the 3D model 710 of FIG. 7) based on at least the positions of the first input and second input, and depth data from the data stream. The presentation module 206 may cause display of the value within the presentation of the 3D model, as illustrated by the value 708 of FIG. 7.

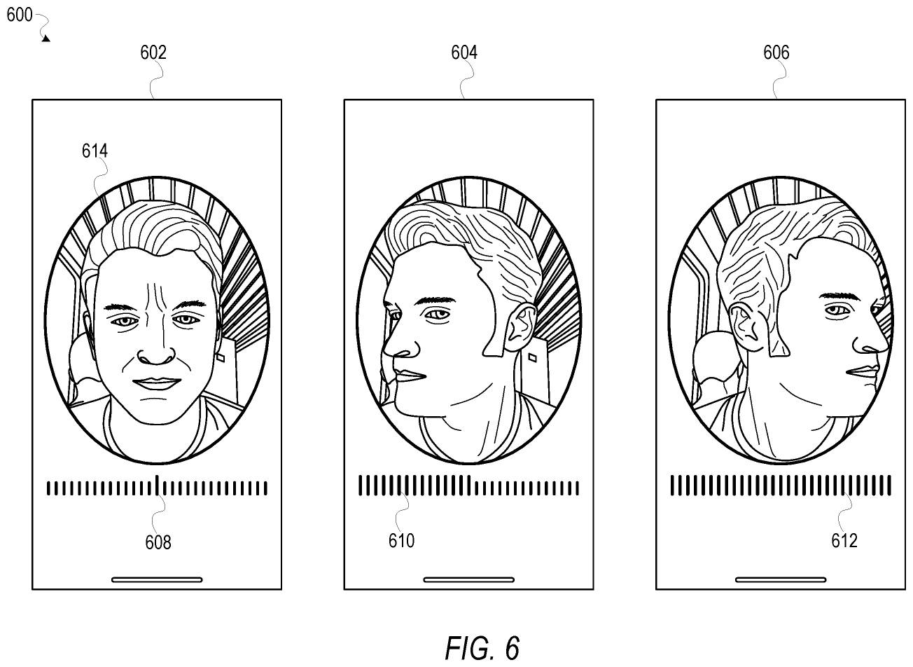

FIG. 6 is an interface flow diagram 600 illustrating interfaces presented by the measurement system 124, according to certain example embodiments, and as discussed in the method 300 depicted in FIG. 3. According to certain example embodiments, the interfaces depicted in the flow diagram 600 may correspond with operation 302 of the method 300, wherein the 3D measurement system accesses a data stream at a client device 102.

For example, as discussed in operation 302 of the method 300, the data stream module 202 accesses one or more input components of the client device 102 which generate the data stream. The data stream may comprise image data, RBG data, depth data, IMU data, client device information, as well as geolocation information.

According to certain embodiments, and as seen in interface 602, the presentation module 206 may cause display of image data 614 associated with the data stream at a position within a GUI at the client device 102. The GUI may also include a display of an indicator 608, wherein the indicator 608 provides an indication of an amount of data from the data stream that has been collected, and an amount of data from the data stream that remains to be collected.

For example, in order to generate a 3D model of an object depicted by the data stream, a minimum amount of data depicting surfaces of the object must be collected by the 3D measurement system 124. Accordingly, upon detecting a depiction of an object in the data stream, the 3D measurement system 124 may present the indicator 608 to provide the user with an indication of whether a minimum amount data has been collected to accurately model the object.

Responsive to receiving a first portion of data from the data stream, the presentation module 206 causes display of the indicator 610, as seen in interface 604. Similarly, responsive to receiving a second portion of data form the data stream, the presentation module 206 causes display of the indicator 612, as seen in the interface 606.

In some embodiments, the presentation module 206 may additionally provide a user of the client device 102 with haptic feedback. For example, the haptic feedback may include vibrations to indicate that depth data is actively being collected via the data stream.

FIG. 7 is a diagram 700 depicting a presentation of a value of a dimension, according to certain example embodiments. As seen in the diagram 700, the 3D measurement system 124 may present a 3D model 710 of an object depicted by a data stream that comprises image data and depth data. A user of the client device 102 may provide inputs selecting points 702, 704, and 706. Responsive to receiving the inputs, the 3D measurement system 124 may identify one or more dimensions associated with the 3D model 710, and generate and cause display of a value 708.

### Software Architecture

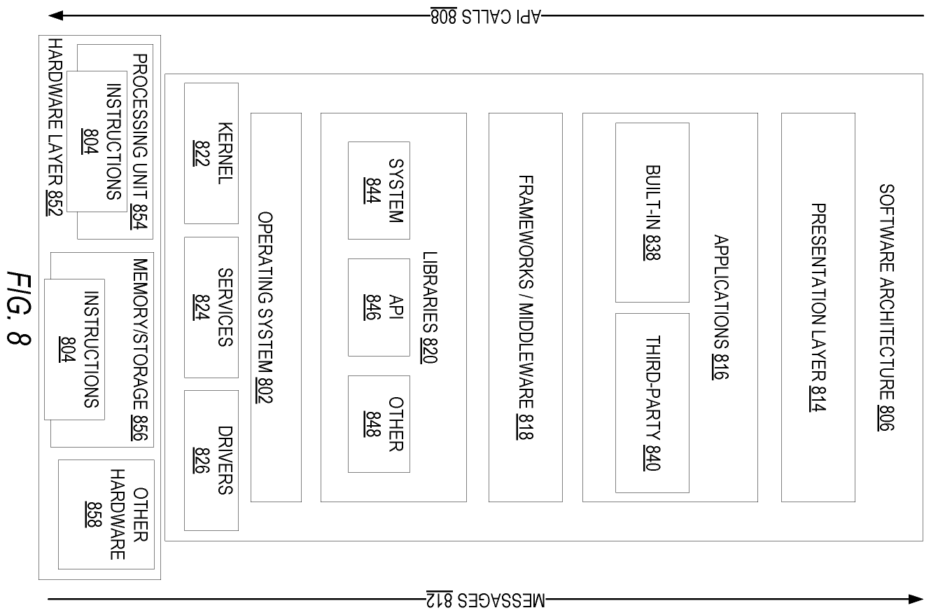

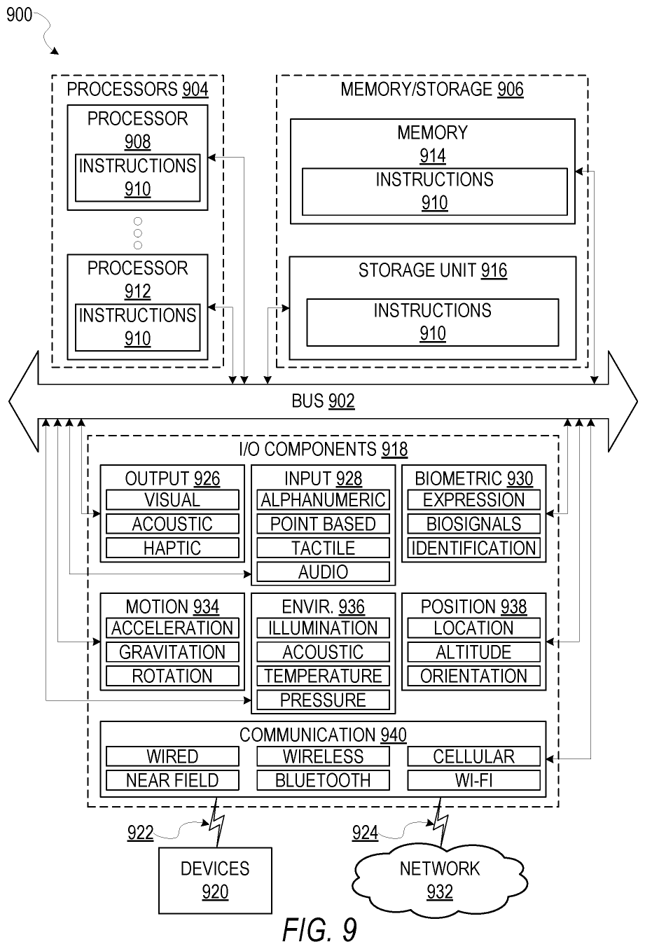

FIG. 8 is a block diagram illustrating an example software architecture 806, which may be used in conjunction with various hardware architectures herein described. FIG. 8 is a non-limiting example of a software architecture and it will be appreciated that many other architectures may be implemented to facilitate the functionality described herein. The software architecture 806 may execute on hardware such as the machine 900 of FIG. 9 that includes, among other things, processors 804, memory 814, and I/O components 818. A representative hardware layer 852 is illustrated and can represent, for example, the machine 800 of FIG. 8. The representative hardware layer 852 includes a processing unit 854 having associated executable instructions 804. Executable instructions 804 represent the executable instructions of the software architecture 806, including implementation of the methods, components and so forth described herein. The hardware layer 852 also includes memory and/or storage modules memory/storage 856, which also have executable instructions 804. The hardware layer 852 may also comprise other hardware 858.

In the example architecture of FIG. 8, the software architecture 806 may be conceptualized as a stack of layers where each layer provides particular functionality. For example, the software architecture 806 may include layers such as an operating system 802, libraries 820, applications 816 and a presentation layer 814. Operationally, the applications 816 and/or other components within the layers may invoke application programming interface (API) API calls 808 through the software stack and receive a response as in response to the API calls 808. The layers illustrated are representative in nature and not all software architectures have all layers. For example, some mobile or special purpose operating systems may not provide a frameworks/middleware 818, while others may provide such a layer. Other software architectures may include additional or different layers.

The operating system 802 may manage hardware resources and provide common services. The operating system 802 may include, for example, a kernel 822, services 824 and drivers 826. The kernel 822 may act as an abstraction layer between the hardware and the other software layers. For example, the kernel 822 may be responsible for memory management, processor management (e.g., scheduling), component management, networking, security settings, and so on. The services 824 may provide other common services for the other software layers. The drivers 826 are responsible for controlling or interfacing with the underlying hardware. For instance, the drivers 826 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 820 provide a common infrastructure that is used by the applications 816 and/or other components and/or layers. The libraries 820 provide functionality that allows other software components to perform tasks in an easier fashion than to interface directly with the underlying operating system 802 functionality (e.g., kernel 822, services 824 and/or drivers 826). The libraries 820 may include system libraries 844 (e.g., C standard library) that may provide functions such as memory allocation functions, string manipulation functions, mathematical functions, and the like. In addition, the libraries 820 may include API libraries 846 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 820 may also include a wide variety of other libraries 848 to provide many other APIs to the applications 816 and other software components/modules.

The frameworks/middleware 818 (also sometimes referred to as middleware) provide a higher-level common infrastructure that may be used by the applications 816 and/or other software components/modules. For example, the frameworks/middleware 818 may provide various graphic user interface (GUI) functions, high-level resource management, high-level location services, and so forth. The frameworks/middleware 818 may provide a broad spectrum of other APIs that may be utilized by the applications 816 and/or other software components/modules, some of which may be specific to a particular operating system 802 or platform.

The applications 816 include built-in applications 838 and/or third-party applications 840. Examples of representative built-in applications 838 may include, but are not limited to, a contacts application, a browser application, a book reader application, a location application, a media application, a messaging application, and/or a game application. Third-party applications 840 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 840 may invoke the API calls 808 provided by the mobile operating system (such as operating system 802) to facilitate functionality described herein.

The applications 816 may use built in operating system functions (e.g., kernel 822, services 824 and/or drivers 826), libraries 820, and frameworks/middleware 818 to create user interfaces to interact with users of the system. Alternatively, or additionally, in some systems interactions with a user may occur through a presentation layer, such as presentation layer 814. In these systems, the application/component “logic” can be separated from the aspects of the application/component that interact with a user.

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 910 (e.g., software, a program, an application, an applet, an app, or other executable code) for causing the machine 900 to perform any one or more of the methodologies discussed herein may be executed. As such, the instructions 910 may be used to implement modules or components described herein. The instructions 910 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 910, sequentially or otherwise, that specify actions to be taken by machine 900. Further, while only a single machine 900 is illustrated, the term “machine” shall also be taken to include a collection of machines that individually or jointly execute the instructions 910 to perform any one or more of the methodologies discussed herein.

The machine 900 may include processors 904, memory memory/storage 906, and I/O components 918, which may be configured to communicate with each other such as via a bus 902. The memory/storage 906 may include a memory 914, such as a main memory, or other memory storage, and a storage unit 916, both accessible to the processors 904 such as via the bus 902. The storage unit 916 and memory 914 store the instructions 910 embodying any one or more of the methodologies or functions described herein. The instructions 910 may also reside, completely or partially, within the memory 914, within the storage unit 916, within at least one of the processors 904 (e.g., within the processor's cache memory), or any suitable combination thereof, during execution thereof by the machine 900. Accordingly, the memory 914, the storage unit 916, and the memory of processors 904 are examples of machine-readable media.

The I/O components 918 may include a wide variety of components to receive input, provide output, produce output, transmit information, exchange information, capture measurements, and so on. The specific I/O components 918 that are included in a particular machine 900 will depend on the type of machine. For example, portable machines such as mobile phones will likely include a touch input device or other such input mechanisms, while a headless server machine will likely not include such a touch input device. It will be appreciated that the I/O components 918 may include many other components that are not shown in FIG. 9. The I/O components 918 are grouped according to functionality merely for simplifying the following discussion and the grouping is in no way limiting. In various example embodiments, the I/O components 918 may include output components 926 and input components 928. The output components 926 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 928 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 918 may include biometric components 930, motion components 934, environmental environment components 936, or position components 938 among a wide array of other components. For example, the biometric components 930 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 934 may include acceleration sensor components (e.g., accelerometer), gravitation sensor components, rotation sensor components (e.g., gyroscope), and so forth. The environment components 936 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 938 may include location sensor components (e.g., a Global Position system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 918 may include communication components 940 operable to couple the machine 900 to a network 932 or devices 920 via coupling 922 and coupling 924 respectively. For example, the communication components 940 may include a network interface component or other suitable device to interface with the network 932. In further examples, communication components 940 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 920 may be another machine or any of a wide variety of peripheral devices (e.g., a peripheral device coupled via a Universal Serial Bus (USB)).

Moreover, the communication components 940 may detect identifiers or include components operable to detect identifiers. For example, the communication components 940 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 940, such as, location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols.

“CLIENT DEVICE” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“EMPHEMERAL MESSAGE” in this context refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“MACHINE-READABLE MEDIUM” in this context refers to a component, device or other tangible media able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“TIMESTAMP” in this context refers to a sequence of characters or encoded information identifying when a certain event occurred, for example giving date and time of day, sometimes accurate to a small fraction of a second.

“3D RECONSTRUCTION” in this context refers to a process of building a 3D model using multiple pieces of partial information about a subject.

“3D SCAN” in this context refers to the result of a 3D reconstruction.

“SIMULTANEOUS LOCATION AND MAPPING (SLAM)” in this context refers to a method of building a map or model of an unknown scene or subject while simultaneously keeping track of a device position within an environment.

“DEPTH FRAME” in this context refers to a snapshot in time of depth values from a sensor, arranged in a 2D grid, like an RGB camera frame. In certain embodiments the depth values are the distance in meters from a device to a subject.

“POINT CLOUD” in this context refers to and unordered array of points in 3D, wherein each point has an XYZ position, a color, a normal (which is a vector indicating the point's orientation), and other information.

“MESH” in this context refers to a collection of triangles.

What is claimed is:

1. A system comprising:
a memory; and
at least one hardware processor coupled to the memory and comprising instructions that causes the system to perform operations comprising:
accessing a data stream at a client device, the data stream comprising depth data;
generating a 3D model based on at least the depth data;
causing display of a presentation of the 3D model at the client device;
receiving an input that selects a dimension of the 3D model; and
causing display of a value based on the dimension in response to the input that selects the dimension.

2. The system of claim 1, wherein the instructions further comprise:
accessing a collection of data objects, each data object among the collection of data objects comprising a set of attributes;
filtering the collection of data objects based on the value and the set of attributes that correspond with each data object among the collection of data objects; and
causing display of a portion of the collection of data objects in response to the filtering the collection of data objects based on the value.

3. The system of claim 1, wherein the receiving the input that selects the dimension of the 3D model includes:
receiving a first input that identifies a first point within the presentation of the 3D model;
receiving a second input that identifies a second point within the presentation of the 3D model;
receiving a third input that identifies a third point within the presentation of the 3D model;
identifying the dimension based on the first point, the second point, and the third point; and
generating the value based on the dimension.

4. The system of claim 1, wherein the data stream comprises the depth data and image data, and the instructions further comprise:
identifying an object depicted in the data stream based on the image data;
presenting a set of dimensions based on the object, the set of dimensions including the dimension; and
receiving the input that selects the dimension from among the set of dimensions via the client device.

5. The system of claim 1, wherein the causing display of the value based on the dimension in response to the input that selects the dimension includes:
calculating the value based on the depth data.

6. The system of claim 1, wherein the data stream comprises a first portion and a second portion, and the accessing the data stream that comprises depth data further comprises:
causing display of a first visual indicator at the client device in response to receiving the first portion of the data stream; and
causing display of a second visual indicator at the client device in response to receiving the second portion of the data stream.

7. The system of claim 1, wherein the receiving the input that selects the dimension of the 3D model includes:
presenting an indication of the dimension at a position in the presentation of the 3D model at the client device.

8. A method comprising:
accessing a data stream at a client device, the data stream comprising depth data;
generating a 3D model based on at least the depth data;
causing display of a presentation of the 3D model at the client device;
receiving an input that selects a dimension of the 3D model; and
causing display of a value based on the dimension in response to the input that selects the dimension.

9. The method of claim 8, wherein the method further comprises:
accessing a collection of data objects, each data object among the collection of data objects comprising a set of attributes;
filtering the collection of data objects based on the value and the set of attributes that correspond with each data object among the collection of data objects; and
causing display of a portion of the collection of data objects in response to the filtering the collection of data objects based on the value.

10. The method of claim 8, wherein the receiving the input that selects the dimension of the 3D model includes:
receiving a first input that identifies a first point within the presentation of the 3D model;
receiving a second input that identifies a second point within the presentation of the 3D model;
receiving a third input that identifies a third point within the presentation of the 3D model;
identifying the dimension based on the first point, the second point, and the third point; and
generating the value based on the dimension.

11. The method of claim 8, wherein the data stream comprises the depth data and image data, and the method further comprises:
identifying an object depicted in the data stream based on the image data;
presenting a set of dimensions based on the object, the set of dimensions including the dimension; and
receiving the input that selects the dimension from among the set of dimensions via the client device.

12. The method of claim 8, wherein the causing display of the value based on the dimension in response to the input that selects the dimension includes:
calculating the value based on the depth data.

13. The method of claim 8, wherein the data stream comprises a first portion and a second portion, and the accessing the data stream that comprises depth data further comprises:
causing display of a first visual indicator at the client device in response to receiving the first portion of the data stream; and
causing display of a second visual indicator at the client device in response to receiving the second portion of the data stream.

14. The method of claim 8, wherein the receiving the input that selects the dimension of the 3D model includes:
presenting an indication of the dimension at a position in the presentation of the 3D model at the client device.

15. A non-transitory machine-readable storage medium, storing instructions which, when executed by at least one processor of a machine, cause the machine to perform operations comprising:
accessing a data stream at a client device, the data stream comprising depth data;
generating a 3D model based on at least the depth data;
causing display of a presentation of the 3D model at the client device;
receiving an input that selects a dimension of the 3D model; and
causing display of a value based on the dimension in response to the input that selects the dimension.

16. The non-transitory machine-readable storage medium of claim 15, wherein the operations further comprise:
accessing a collection of data objects, each data object among the collection of data objects comprising a set of attributes;
filtering the collection of data objects based on the value and the set of attributes that correspond with each data object among the collection of data objects; and
causing display of a portion of the collection of data objects in response to the filtering the collection of data objects based on the value.

17. The non-transitory machine-readable storage medium of claim 15, wherein the receiving the input that selects the dimension of the 3D model includes:
receiving a first input that identifies a first point within the presentation of the 3D model;
receiving a second input that identifies a second point within the presentation of the 3D model;
receiving a third input that identifies a third point within the presentation of the 3D model;
identifying the dimension based on the first point, the second point, and the third point; and
generating the value based on the dimension.

18. The non-transitory machine-readable storage medium of claim 15, wherein the data stream comprises the depth data and image data, and the operations further comprise:
identifying an object depicted in the data stream based on the image data;
presenting a set of dimensions based on the object, the set of dimensions including the dimension; and
receiving the input that selects the dimension from among the set of dimensions via the client device.

19. The non-transitory machine-readable storage medium of claim 15, wherein the causing display of the value based on the dimension in response to the input that selects the dimension includes:
calculating the value based on the depth data.

20. The non-transitory machine-readable storage medium of claim 15, wherein the data stream comprises a first portion and a second portion, and the accessing the data stream that comprises depth data further comprises:
causing display of a first visual indicator at the client device in response to receiving the first portion of the data stream; and
causing display of a second visual indicator at the client device in response to receiving the second portion of the data stream.
